(19) United States
(12) Patent Application Publication
(10) Pub. No.: US 2008/0087788 A1
(43) Pub. Date: Apr. 17, 2008

(54) Height adjusting device

(76) Inventors: Ko-Po Cheng, Tali City (TW); Meng-Long Fang, Tali City (TW)

Correspondence Address: TROXELL LAW OFFICE PLLC, SUITE 1404, 5205 LEESBURG PIKE, FALLS CHURCH, VA, 22041, US

(21) Appl. No.: 11/580,294

(22) Filed: Oct. 13, 2006

(51) Int. Cl. F16M 11/00

(52) U.S. Cl. 248/404

(57) ABSTRACT

A height adjustable device includes two main bodies installed to correspondingly parallel each other, and a power device installed to move between the main bodies. Each main body has a long rack positioned at its one side, having teeth facing to those of another correspondingly. The power device has a main box, a power source set inside the main box, and plural guiding wheels. The power source is connected with shafts extending out of the main box to form as extended shafts that are respectively fixed with a gear to engage with the long racks to keep the main bodies moving up and down in mutually opposite directions, doubling a distance to be moved for using.

### BACKGROUND OF THE INVENTION

1. Field of the invention

This invention relates to a height adjustable device, particularly to one able to double a distance to be moved up and down.

2. Description of the Prior Art

As shown in FIGS. 1 and 2, a conventional electrical height-adjustable device for a table is composed of a main frame 10 and a motor 20. The main frame 10 is provided with two moving bases 11 located at its two sides respectively to move up and down, and a tabletop 12 positioned firmly on the moving base 11 so as to slide with the moving base 11 correspondingly. The main frame 10 is provided with two moving bases 11 located at its two sides respectively to move up and down, a tabletop 12 positioned firmly on the moving bases 11 so as to slide with the 11 correspondingly, and a vertical rack 23 located at an inner side of the main frames respectively. The motor 20 installed under the tabletop 12 is provided additionally with a pivotal shaft 21 connected pivotally with the moving bases 11, a gear 22 fixed at two ends of the pivotal shaft 21 respectively and the vertical rack 23 respectively engages with the gear 22. The motor 20 installed under the tabletop 12 is provided additionally with a pivotal shaft 21 connected pivotally with the moving bases 11, and a gear 22 fixed at two ends of the pivotal shaft 21 respectively for engaging with the gear 22. Therefore, the pivotal shaft 21 can be therein driven to rotate clockwise or counterclockwise by the motor 20 to keep the tabletop 12 raised or descended.

But, the conventional height adjustable device can move within a range as long as the length of the vertical rack 23 or even shorter owing to the occupation of the gears 22, unable to satisfy practical requirement. Also, such a conventional height-adjustable device has to be installed at two sides of the table respectively, causing a complicated and inconvenient assembly.

### SUMMARY OF THE INVENTION

The objective of this invention is to offer a height-adjustable device.

The main characteristics of the invention are two main bodies installed to correspondingly parallel each other and a power device.

Each of the main bodies is provided with a long rack at its two sides respectively, having teeth facing to those of another one correspondingly. The power device is provided with a main box, a power source set inside the main box, and plural guiding wheels. The power source is connected with shafts extending out of the main box to form as extended shafts that are respectively fixed with a gear to engage with the long racks to keep the main bodies moving up and down for a doubled distance in mutually opposite directions, giving more space for a user to use. In addition, it is very easy to assemble the invention, able to avoid complicated assembly for saving time.

### BRIEF DESCRIPTION OF DRAWINGS

This invention is better understood by referring to the accompanying drawings, wherein:

FIG. 1 is a perspective view of a conventional height adjustable device for a table;

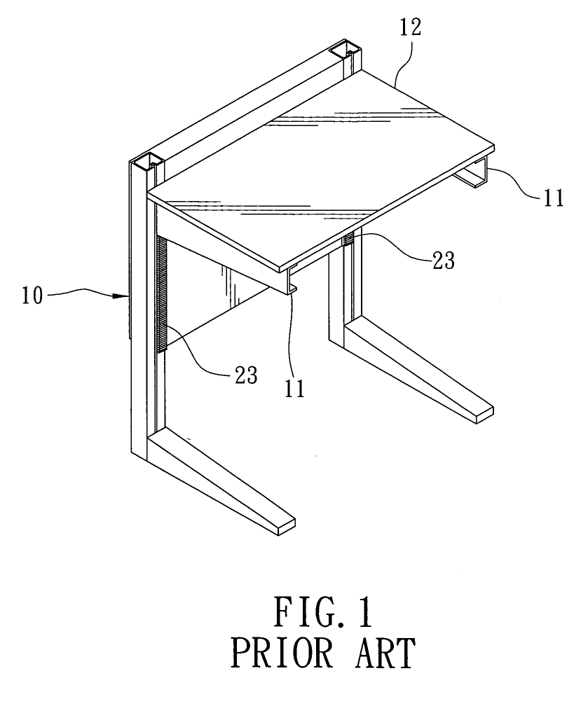

FIG. 2 is a front view of the conventional height adjustable device for a table;

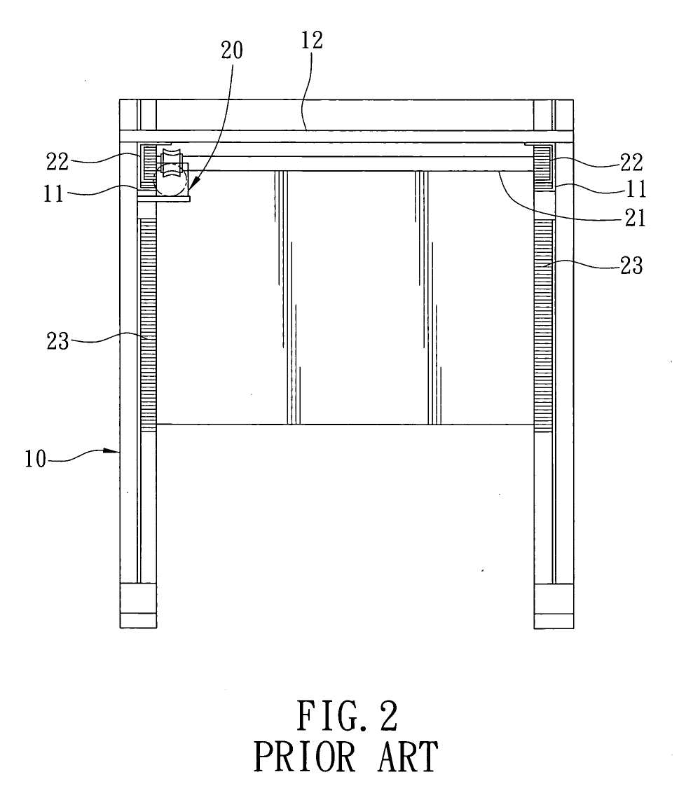

FIG. 3 is an exploded perspective view of a first preferred embodiment of a height adjustable device in the present invention;

FIG. 4 is a side view of the first preferred embodiment of a height adjustable device in the present invention, showing how it works;

FIG. 5 is a side view of the first preferred embodiment of a height adjustable device in the present invention, showing it being applied in a way;

FIG. 6 is a side view of the first preferred embodiment of a height adjustable device in the present invention, showing it being applied in another way;

FIG. 7 is a perspective view of the preferred embodiment of a height adjustable device in the present invention, showing it being adjusted; and

FIG. 8 is a perspective view of a second preferred embodiment of a height adjustable device in the present invention.

### DETAILED DESCRIPTION OF THE PREFERRED EMBODIMENT

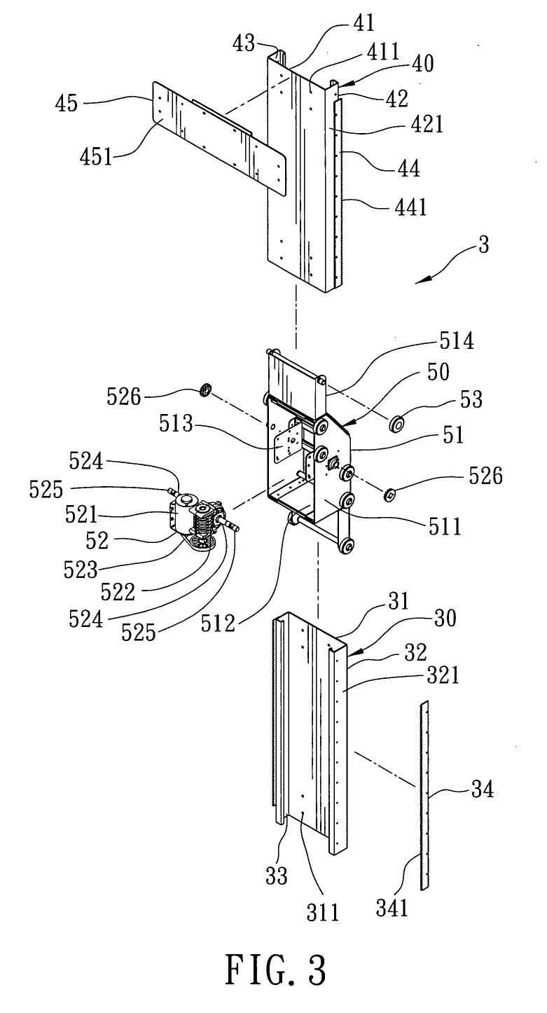

As shown in FIG. 3, a first preferred embodiment of a height adjustable device 3 in the present invention is provided with a first main body 30, a second main body 40 and a power device 50.

The first main body 30 is provided with a main board 31 in its dominant intermediate portion, a L-shaped side board 32 jointed vertically with two sides of the main board 31 respectively, a guiding rail 33 formed by an interior space surrounded by the side boards 32 and the main board 31 for restricting direction of sliding, and a long rack 34 set fixedly on an exterior wall 321 of each of the side boards 32 respectively and provided with teeth 341 on its one side. The main board 31 is additionally provided with a preset number of assembling holes 311 bored in its upper and lower portions. The main board 31 and the sideboards 32 are formed integrally from a sheet of metal. Of course, it can also be made by assembling the main board 31 with the sideboards 32 independently shaped with the guiding rails 33 in advance.

The second main body 40 installed to parallel with the first main body 30 correspondingly is provided with a main board 41 in its dominant intermediate portion, an L-shaped side board 42 jointed vertically with two sides of the main board 41 respectively, a guiding rail 43 formed by an interior space surrounded by the side boards 42 and the main board 41 for restricting direction of sliding, and a long rack 44 set fixedly on an exterior wall 421 of each of the side boards 42 respectively provided with teeth 441 on its one side facing toward the teeth 341 of the fist main body 30 correspondingly. The formation of the second main body 40 can be achieved by shaping integrally with a sheet of metal or assembling the main board 41 with the side boards 42 like that of the first main body 30. In addition, the second main body 40 is provided with an extra board 45 fixed firmly at its top and provided with an vertical assembling surface 451, wider than the second main body 40 for hanging or screwed together with an object.

The power device 50 set movably between the fist main body 30 and the second main body 40 is composed of a main box 51, a power source 52 and plural guiding wheels 53. The main box 50 is provided with a rectangular box 511 formed integrally of a sheet, a containing chamber 512 surrounded by the rectangular box 511, and two fixing boards 513 fixed respectively on two walls of the rectangular box 511 inside the containing chamber 512. The power source 52 is provided with a motor 521 sandwiched firmly on the fixing boards 513, a reduction device 522 linked with the motor 521 by a pulley 523, a shaft 524 connected to two sides of the motor 521 respectively and having an extended shaft 525 exposed outside the main box 51, and a gear 526 fixed at the end of each of the extended shafts 525 respectively for engaging correspondingly with the teeth 341 and 441 of the first main body 30 and the second main body 40 to enable the long racks 34 and 44 to move in opposite directions. The guiding wheels 53 pivotally set on the exterior walls 514 of two sides of the main box 51 are aligned at two sides of the gear 526 with pairs symmetrically spaced apart, able to slide in the guiding rails 33 and 43 so as to drive the first main body 30 and the second main body 40 to move up and down stably and alternately.

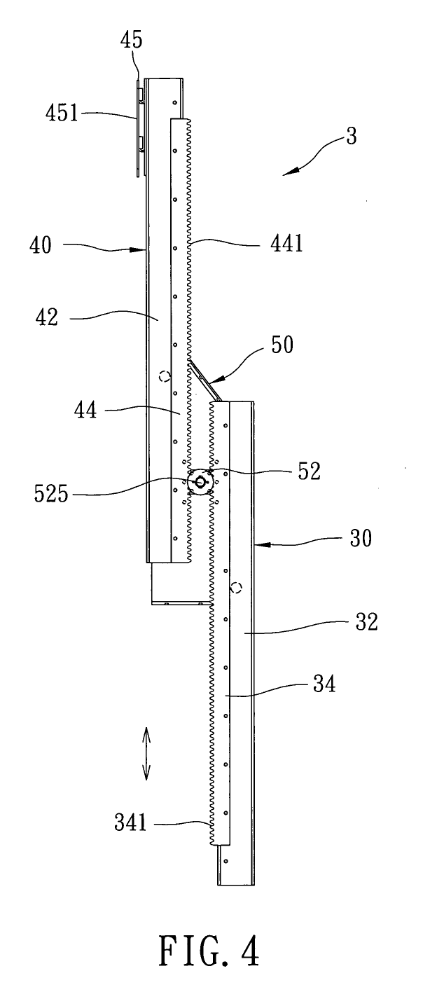

In using, as shown in FIGS. 3 and 4, when the motor 521 is turned on, the pulley 523 is to drive the reduction device 522 to keep the shafts 524 rotated, and then the gears 526 engaged respectively with the teeth 341 and 441 are successively driven to rotate to enable the first main body 30 and the second main body 40 to move in mutually opposite directions. As the first main body 30 and the second main body 40 always move in the opposite directions, a doubled length is available for the invention to move, giving more space for a user to use. Also, the invention can move safely to prevent object hung from dropping owing to the reduction device 522 able to reduce rising and descending speed.

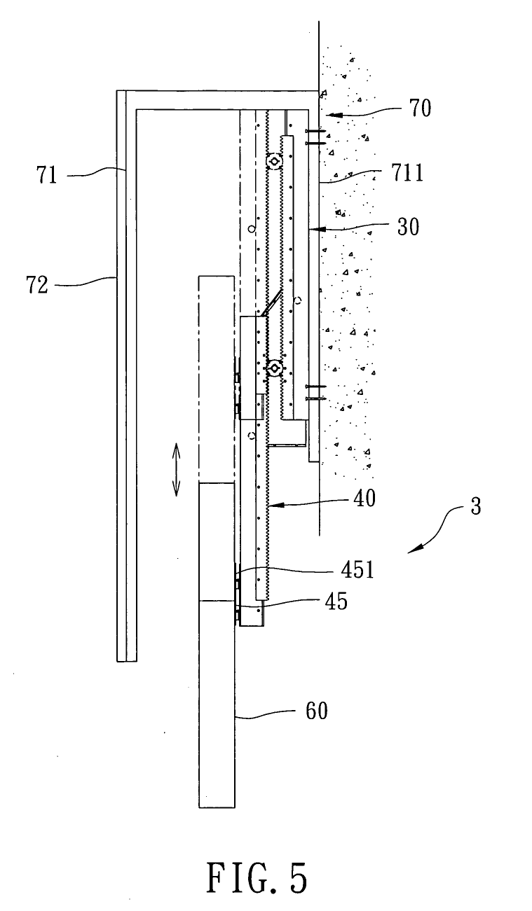

As shown in FIG. 5, it shows how to use the invention installed on a wall 70. The extra board 45 can be fixed with an object, such as a thin plasma TV or a thin LCD TV 60. The wall 70 is installed with a decoration frame 71 provided with an interior wall 711 for fixing with the first main body 30 so that the second main body 40 can move up and down against it. So, the TV 60 can be moved down away the decoration frame 71 for watching or up to hide in the decoration frame 71 while not watching. The decoration frame 71 can also be furnished with a painting on its exterior wall to improve indoor view.

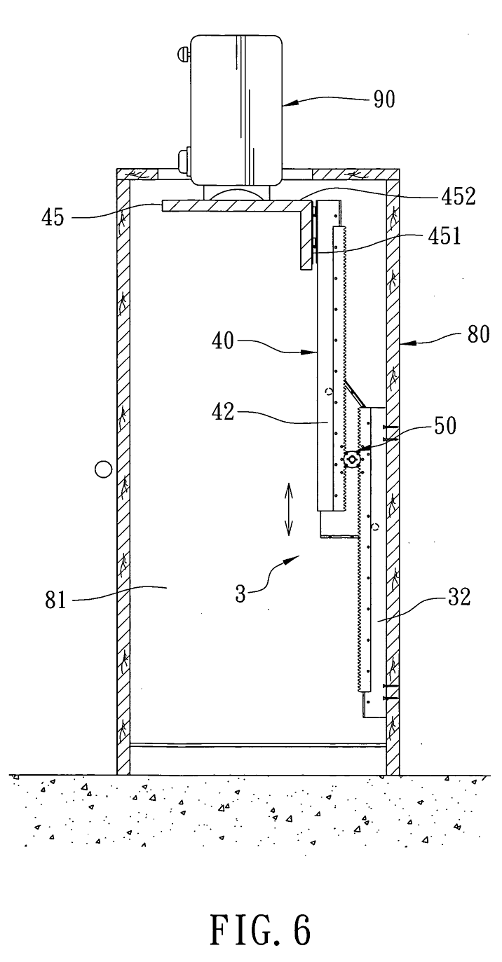

As shown in FIG. 6, it shows how to use the invention installed in a storing chamber 81 of a cupboard 80. The extra board 45 L-shaped is provided with the assembling surface 451 fixed on the top of the second main body 40 and a horizontal placing surface 452 for carrying a household electric appliance 90, such as a microwave oven or a common oven. So, just turn on the invention to let it move to a proper position from the cupboard 80 if the household electric appliance 90 is to be used, and move back in the storing chamber 81 of the cupboard 80 while not using.

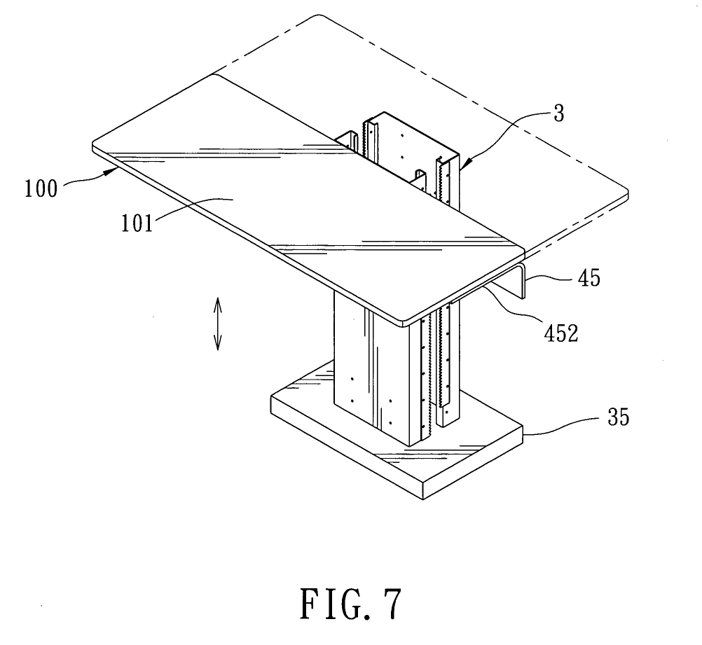

As shown in FIG. 7, it shows how to use the invention installed under a tabletop 101 of a table 100. The tabletop 101 is placed on the placing surface 452. There is a stand 35 fixed beneath the invention 3 to keep the invention 3 able to carry the tabletop 101 to move up and down stably. The tabletop 101 can be moved up and down by the invention if it is to be used, and stored up so as to save space.

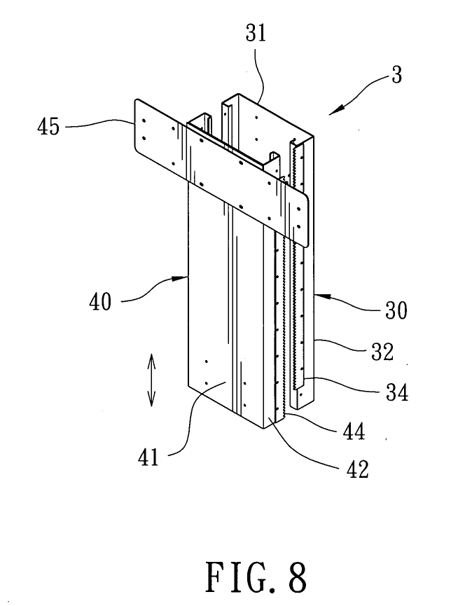

As shown in FIG. 8, a second preferred embodiment of a height-adjustable device 3 in the present invention has the same parts, as the first preferred embodiment does except that it is provided with the long racks 34 and 44 at its one side only, for carrying a light object without any risk of losing its center of gravity.

The invention has the following advantages as can be seen from the foresaid description. First, the first main body 30 and the second main body 40 can be moved in mutually opposite directions by means of the long racks 34 and 44 driven by the power device 50, enabling the invention to move for a doubled distance so as to give more space for a user to use. Second, the moving speed of the invention is slowed down by the reduction device 522 linked with the motor 521, so that an object carried by the invention is to stay safely therein while being moved up and down. Third, it is very easy to assemble the invention, able to avoid complicated assembly for saving time.

While the preferred embodiment of the invention has been described above, it will be recognized and understood that various modifications may be made therein and the appended claims are intended to cover all such modifications that may fall within the spirit and scope of the invention.

What is claimed is:

1. A height adjustable device comprising:
two main bodies installed to parallel each other correspondingly, each of said main bodies provided with a guiding rail located at its two longitudinal sides respectively for restricting its moving direction, and a long rack fixed at a preset location adjacent to each of said guiding rails, each said long rack provided with teeth facing correspondingly to each other, one of said main bodies fixed firmly at a preset position for the other one to move up and down against it; and
a power device installed to move between said two main bodies and provided with a main box, a power source and plural guiding wheels, said power source set inside said main box and provided with two shafts that are respectively extended out of said box to form as an extended shaft, and a gear fixed at the end of each of said extended shafts respectively for engaging correspondingly with said teeth of two said two main bodies to enable said long racks of said two main bodies to move in mutually opposite directions, said guiding wheels pivotally set on exterior walls of two sides of said main box and aligned at two sides of said gear with pairs spaced apart symmetrically for sliding restrictively along said guiding rails so as to keep two said main bodies to move up and down stably and alternately.

2. A height adjustable device as claimed in claim 1, wherein each said main body is provided with a main board in its dominant intermediate portion, an L-shaped side board jointed longitudinally and vertically with two sides of said main board respectively, and said guiding rail formed by an interior space surrounded by said side boards and said main board for restricting direction of sliding, said main board provided with a preset number of assembling holes bored in an upper and a lower portion, said long rack set fixedly on an exterior wall of each of said side boards respectively with its teeth facing correspondingly to each other, said main box of said power device provided with a rectangular box formed integrally of a sheet, a containing chamber surrounded by said rectangular box, two fixing board fixed to space apart inside said containing chamber, said power source provided with a motor sandwiched firmly on said two fixing boards.

3. A height adjustable device as claimed in claim 2, wherein said power source is said motor connected with a reduction device via a pulley, said shafts connected at two sides of said reduction device.

4. A height adjustable device as claimed in claim 1, wherein said main board and said side boards of said main body are formed integrally of a sheet of metal.

5. A height adjustable device as claimed in claim 2, wherein said main board is assembled together with said side boards that are independently shaped with said guiding rails in advance.

6. A height adjustable device as claimed in claim 1, wherein one of said main bodies able to move up and down is provided with an extra board positioned at an upper or a lower end.
